(19) United States
(12) Patent Application Publication
(10) Pub. No.: US 2015/0065206 A1
(43) Pub. Date: Mar. 5, 2015

(54) Locking Rim Cell Phone Case

(71) Applicant: David Rojas, Santa Monica, CA (US)

(72) Inventor: David Rojas, Santa Monica, CA (US)

(73) Assignee: Evutec Corporation, Walnut, CA (US)

(21) Appl. No.: 14/013,385

(22) Filed: Aug. 29, 2013

(51) Int. Cl. H04M 1/02

(52) U.S. Cl. CPC H04M 1/0202
USPC 455/575.1

(57) ABSTRACT

A cellular phone case includes an insert panel. The insert panel is flat and has an insert panel height with an insert panel width. A locking rim includes four sections, namely a first section, a second section, a third section and a fourth section. The first section is a rigid link, the second section is a rigid link, the third section is a rigid link, and the fourth section is a rigid link. The locking rim includes a hinge mechanism that has an open position that is extended and a closed position for retaining a cell phone. The first section is connected to the second section at a first hinge. The second section is connected to the third section at a second hinge. The third section is connected to the fourth section and a third hinge. The fourth section is connected to the first section at a locking connection.

### FIELD OF THE INVENTION

The present invention is in the field of cellular phone cases.

### DISCUSSION OF RELATED ART

The basic function of cellular phone cases is to protect the outer shell of such phones from scratches, nicks, and other physical damage. The design of cellular phone cases typically consist of a backing, which is composed of either a hard backing or a soft pliable material (to absorb shock, if dropped), and raised sides that envelop the edges. Joel Rodger's U.S. design publication No. 671,933, filed Feb. 3, 2013, is entitled Cell Phone Case, the disclosure of which is incorporated herein by reference. The illustrations display a phone cover, which has the distinct feature of a striated backing. There are also openings to allow for the insertion of plugs and maintain the ability to use the camera without having to remove the case. Another phone case as developed by Becky Kasselman and Frances Ray, U.S. publication number 2011/0294542, filed May 27, 2010, entitled Cell Phone Cover with Integrated Mirror and Flip Shield, consists of a cell phone case that covers the back and the front of the case, the disclosure of which is incorporated herein by reference. A flip shield is provided on the front of the case to protect the mirror from scratches and damage, whereas, many other cases leave the consumer to find a separate method of protecting the screen.

Other auxiliary features have been added to cell phone cases. Some cell phone cases can be used as brass knuckles. Cellular phone cases have progressed far from its basic function and design. Cases are now a method of expressing an individual's personality, as well as address other needs consumers may desire. Prapanch Soekoro, USD651205, filed on May 6, 2011, entitled Cellphone Case, presents a cellular phone case with an extended area to the right of the case that resembles brass knuckles. The extended portion consists of four circular rings, joined to each other and arches slightly outward.

Earphone storage has also been accomplished by cell phone cases. Since smart phones also enable users to listen to music on their cellular device, phone cases have also evolved to adapt to the new features. One example includes John Merenda USD667823, filed on Sep. 25, 2012, entitled Protective Cover, the disclosure of which is incorporated herein by reference. The cellular phone cover consists of a storage area that houses the ear phones. The ear phones are retractable and thus would not tangle from being stored away arbitrarily in places such as a pocket or a handbag.

Sound amplification has also been accomplished by cell phone cases. The wireless capability of cellular phones is disadvantageous to users with hearing handicaps. Since, the transmission can be distorted through the air, the combination of a weak signal and limited hearing creates a situation that frustrates those users. Kwang Oh U.S. Pat. No. 8,412,289, filed on Feb. 23, 2012, entitled Expendable and Collapsible Sound Amplifying Cellular Phone Case, addresses this concern, the disclosure of which is incorporated herein by reference. Oh's patent for a cell phone case consists of sound outlet areas that are located on the right and left side of the bottom perimeter. The frame's interior further comprises of three horizontally placed sectional chambers that decrease in width from top to bottom.

It is of the present invention to provide a cell phone case that has an open extended position to provide a reaching pole configuration and a closed position for protecting the cell phone.

### SUMMARY OF THE INVENTION

A cellular phone case includes an insert panel. The insert panel is flat and has an insert panel height with an insert panel width. A locking rim includes four sections, namely a first section, a second section, a third section and a fourth section. The first section is a rigid link, the second section is a rigid link, the third section is a rigid link, and the fourth section is a rigid link. The locking rim includes a hinge mechanism that has an open position that is extended and a closed position for retaining a cell phone. The first section is connected to the second section at a first hinge. The second section is connected to the third section at a second hinge. The third section is connected to the fourth section and a third hinge. The fourth section is connected to the first section at a locking connection.

The first hinge, the second hinge, and the third hinge are hinged to rotate in a plane parallel to a plane of the panel insert. The insert panel is made of wood veneer that is generally rectangular and having rounded corners. The insert panel is made of a para-aramid synthetic fiber laminate that is generally rectangular having rounded corners.

The cellular phone case preferably also includes a pair of lower protrusions that have a lower protrusion face that is a flat portion formed on a second hinge third section protrusion and on a third hinge third section protrusion. The lower protrusion face can be formed as a second hinge third section protrusion and a third hinge third section protrusion. A pair of lower protrusions may include a pair of lower protrusion inclines that serve as an interface between a data cutout plate and a lower protrusion face, such that the protrusion incline provides an indented surface of the data cutout plate. The data cutout plate is a flat area of the third section.

A lower portion of the cell phone case has a slot cutout for providing an aperture to access ports of the cell phone. The slot cutout includes a circular cutout and a data cutout. The data cutout can be formed as a rectangular opening. The circular cutout can be formed as a round opening. The circular cutout can be sized to allow a headphone jack to interface with the access ports of the lower portion of the cell phone. The data cutout can be sized to allow a data connector to interface with the access ports of the lower portion of the cell phone. The data cutout is formed on the data cutout plate. The data cutout plate is a flat area of a lower outside surface of the third section.

The cellular phone case preferably also includes a power button plate. The power button plate is a flat indented area between the upper protrusions. The power button plate includes a power button formed as a rigid cap inserted inside a power button opening so that a user pressing the power button can activate a power control of the cell phone. The power button includes a power button stem and a power button flange extending laterally from the power button stem. The power button stem fits through the power button opening by insertion from an inside side of the power button opening and is retained by the power button flange. The power button stem is movable within the power button opening.

A flip switch is mounted on the second section in a flip switch opening. The flip switch is formed as a small button. The flip switch is slidingly mounted in a flip switch slot. The flip switch includes a flip switch flange to retain the flip switch within the flip switch slot. A rocker switch is mounted on the second section in a rocker switch opening. The rocker switch includes a rocker switch first portion and a rocker switch second portion. The rocker switch has a rocker switch flange to retain the rocker switch within the rocker switch opening. A pair of upper protrusions are formed on the first section, and a pair of lower protrusions are formed on the third section.

### BRIEF DESCRIPTION OF THE DRAWINGS

FIG. 1 is a front exploded view diagram of the present invention including the front view and side view of the screwdriver.

FIG. 2 is a front view of the panel insert and the side view of the panel insert.

FIG. 3 is a rear assembled view of the locking rim.

FIG. 4 is a bottom view of the locking rim.

FIG. 5 is a right side view of the locking rim.

FIG. 6 is a front assembled view of the locking rim.

FIG. 7 is a top view of the locking rim.

FIG. 8 is a left side view of the locking rim.

FIG. 9 is an outside view, side view, and top view of the rocker switch.

FIG. 10 is a front side, left side view and top view of the power button.

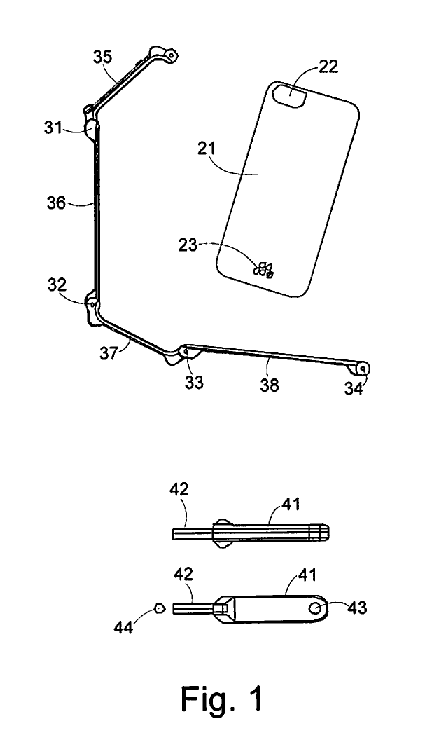

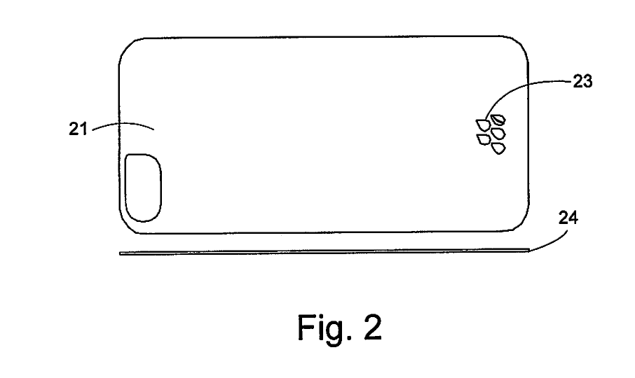

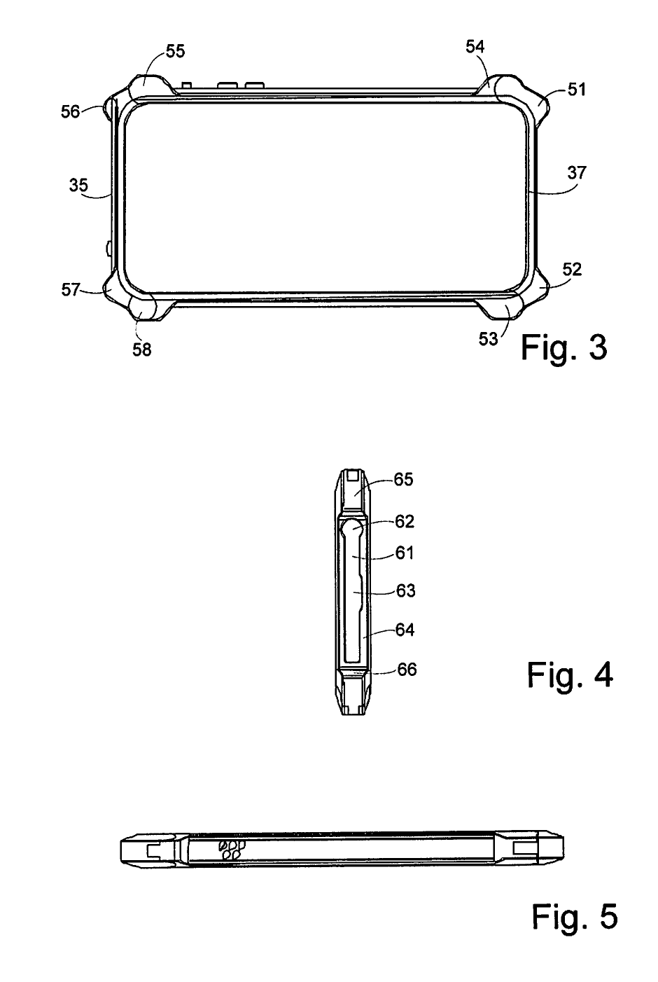

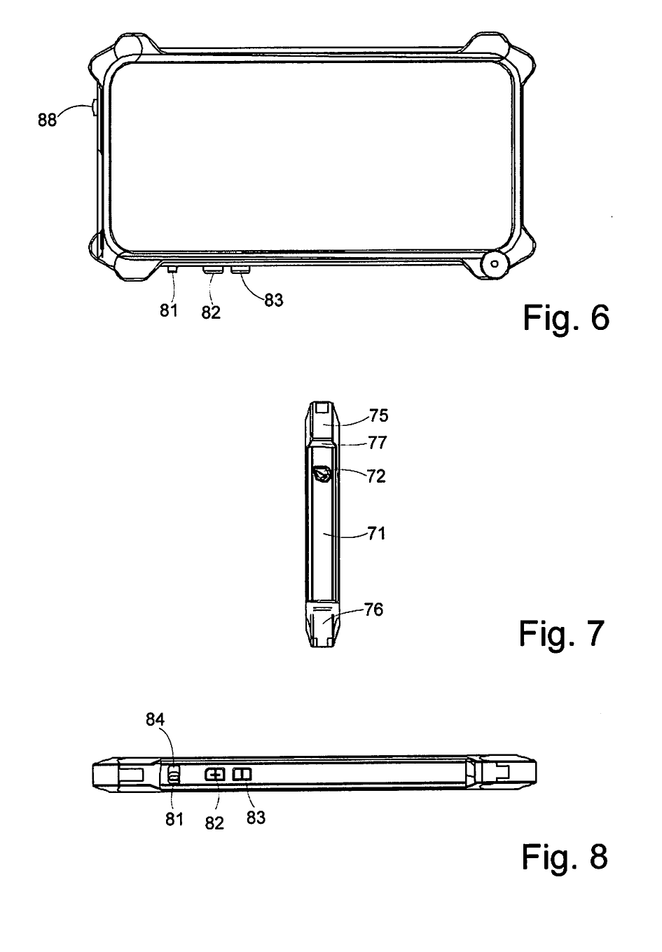

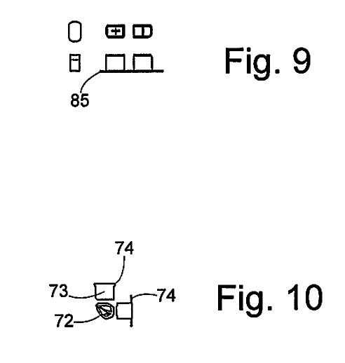

The following call out list of elements can be useful guide in referencing the callout numbers of the drawings.

21 Panel Insert

22 Camera Aperture

23 Marking

31 First Hinge

32 Second Hinge

33 Third Hinge

34 Locking Connection

35 First Section

36 Second Section

37 Third Section

38 Fourth Section

41 Screwdriver Body

42 Screwdriver Shaft

43 Screwdriver Opening

44 Hexagonal Cross Section

51 Second Hinge Third Section Protrusion

52 Third Hinge Third Section Protrusion

53 Third Hinge Second Section Protrusion

54 Second Hinge Fourth Section Protrusion

55 First Hinge Second Protrusion

56 First Hinge First Section Protrusion

57 Locking Connection First Section Protrusion

58 Locking Connection Second Section Protrusion

61 Slot Cutout

62 Circular Cutout

63 Data Cutout

64 Data Cutout Plate

65 Lower Protrusion Face

66 Lower Protrusion Incline

71 Power Button Plate

72 Power Button

73 Power Button Stem

74 Power Button Flange

75 Upper Protrusion Face

76 Locking Connection Protrusion Face

77 Upper Protrusion Incline

81 Flip Switch

82 Rocker Switch First Portion

83 Rocker Switch Second Portion

84 Flip Switch Slot

85 Rocker Switch Flange

88 Power Button Opening

### DETAILED DESCRIPTION OF THE PREFERRED EMBODIMENT

The locking rim cell phone case has a rim that surrounds and frames a panel insert 21. The panel 21 has a camera aperture 22 formed on a portion of the panel insert 21, such as the top left portion of the panel insert 21. The panel insert 21 can be made of wood or a synthetic material such as a sheet of plastic, or a laminate of fiberglass, or a laminate of para-aramid synthetic fiber laminate or carbon fiber. Multiple layers of para-aramid synthetic fiber laminate or carbon fiber can be laminated and formed to make the panel insert 21 having a camera aperture 22 and also having a marking 23. The marking 23 could provide orientation for a user. The panel insert 21 can be made of a five layer laminate having three layers of woven fiber with two layers of epoxy and fiberglass between the three layers of woven fiber. When the panel insert is made of wood, the wood is preferably backed by a sheet of fiberglass or metal. When the panel is made of a synthetic material such as plastic, the panel is preferably a para-aramid synthetic fiber laminate material optionally laminated to a backer such as a fiberglass or metal sheet.

The locking rim includes four sections hinged together. A first hinge 31 hinges a first section 35 to a second section 36. A second hinge 32 hinges a second section 36 to a third section 37. A third hinge 33 hinges a third section 37 to a fourth section 38. A locking connection 34 locks the first section 35 to the fourth section 38. The first section 35 is connected to the second section 36 at a first hinge 31 and the first section 35 is connected to the fourth section 38 at a locking connection 34. The second section 36 is hinge connected to the first section 35 at the first hinge 31 and the second section 36 is hinge connected to the third section 37 at a second hinge 32. The third section 37 is hinge connected to the first section 36 at a second hinge 32, and the third section 37 is hinge connected to the fourth section 38 at the third hinge 33. The hinge connection preferably has a degree of motion sufficient for releasing a cell phone stored within the locking rim. After the locking rim is secured, the four sections and hinges provide a barrier of protection around the cell phone. The sections of the locking rim can be made of metal or plastic. The panel insert is preferably made of wood or para-aramid synthetic fiber laminate that could be printed with a design or shown with exposed woven fibers, but could also be made of metal or plastic.

The locking connection 34 may have a screw that opens via a hexagonal drive screwdriver. The hexagonal drive screwdriver preferably includes a screwdriver body 41, a screwdriver shaft 42, and a screwdriver opening 43 for handling a portion of the screwdriver. The screwdriver shaft 42 preferably has a hexagonal cross section 44. The screwdriver is included with the locking rim cell phone case.

The hinges have a plurality of protrusions that extend outwardly from the hinge pivot. For example, the second hinge 32 has a second hinge third section protrusion 51. The second hinge third section protrusion 51 extends downwardly from a left portion of the third section 37. The third hinge has a third hinge third section protrusion 52 that extends downwardly from a right portion of the third section 27. The third hinge also has a third hinge second section protrusion 53 that protrudes outwardly from the second section. The second hinge has a second hinge fourth section protrusion 54 that protrudes outwardly from the fourth section. The first hinge has a first hinge second section protrusion 55 that extends outwardly from the second section. The first hinge also has a first hinge first section protrusion 56 that protrudes outwardly from the first section. The locking connection has a locking connection first section protrusion 57 that protrudes outwardly from the first section. The locking connection also has a second protrusion noted as the locking connection second section protrusion 58 which protrudes from the second section. The various protrusions that extend outwardly include a pair of protrusions at each hinge. Since each hinge at each corner of the cell phone case is made of a pair of sections, each section provides a protrusion that is hinged together and a single pivot to join the pair of sections.

The lower portion of the cell phone case has a slot cutout 61 for providing an aperture to access portions of the cell phone. The slot cutout 61 may further include a circular cutout 62 and a data cutout 63. The data cutout 63 can be formed as a rectangular opening. The circular cutout 62 can be formed as a round opening. The circular cutout 62 can be sized to allow a headphone jack to interface with the lower portion of the cell phone. The data cutout 63 can be sized to allow a data or charger connector to interface with the lower portion of the cell phone. The data cutout can be formed on the data cutout plate 64 which is a flat area of a lower outside surface of the third section 37. The lower protrusions may further include a lower protrusion face 65 that is a flat portion formed on the second hinge third section protrusion 51 and on the third hinge third section protrusion 52. The lower protrusions include the second hinge third section protrusion 51 and on the third hinge third section protrusion 52. The lower protrusions may have a lower protrusion incline 66 that serves as an interface between the data cutout plate 64 and the lower protrusion face 65, such that the protrusion incline 66 provides an indented surface of the data cutout plate 64.

At an upper portion of the cell phone case, a power button plate can be formed between a pair of upper protrusions. The upper protrusions may include the first hinge first section protrusion 56 and the locking connection first section protrusion 57. The locking connection can be formed as a rigid connection that is screw connected together is a security screw such as a star shaped screw. The upper protrusions may have an upper protrusion face 75 that forms a flat area on both sides of the power button plate 71. The upper protrusion face 75 connects to the power button plate 71 at an upper protrusion incline 77. The upper protrusion incline provides an indent of the power button plate 71 inward from an outside surface of the upper protrusion face 75. The second upper protrusion face can be a locking connection protrusion face 76.

The power button plate is a flat indented area between the upper protrusions. The power button plate 71 preferably further includes a power button 72. The power button 72 is preferably a rigid cap that is inserted inside a power button opening so that a user pressing the power button 72 can activate the power control of the cell phone. The power button 72 preferably includes a power button stem 73 and a power button flange 74. The power button stem 73 fits through the power button opening by insertion from an inside side of the power button opening and is retained by the power button flange 74. The power button stem 73 is movable up and down within the power button opening 88.

A flip switch 81 can be mounted on the second section 36 in a flip switch opening. The flip switch 81 can be formed as a small metal button similar to the configuration of the power button stem. The flip switch 81 is preferably mounted in a flip switch slot 84. The flip switch 81 can be slid along the flip switch slot 84. The flip switch 81 preferably includes a flip switch flange to retain the flip switch within the flip switch slot 84. Adjacent to the flip switch 81 is a rocker switch first portion 82 and a rocker switch second portion 83. The rocker switch preferably has a rocker switch flange 85 to retain the rocker switch within the rocker switch opening. The rocker switch flange 85 preferably connects the rocker switch portions together which includes the rocker switch first portion 82 and the rocker switch second portion 83.

The locking rim generally provides a raised ridge that protects a surface of the cell phone. Additionally, the protrusions protect the cell phone. The panel insert defines a plane that the locking rim hinges in. The hinges are hinged to rotate in a plane parallel to a plane of the panel insert. The present invention locking rim can be extended to an open extended position such that it can be used as an extending pole such as for a back scratcher where a user can hold one of the sections and use a protrusion end of the distant section to scratch a back.

The following claims define the scope of the invention.

1. A cellular phone case comprising:
a. an insert panel, wherein the insert panel is flat and having an insert panel height with an insert panel width;
b. a locking rim including four sections, namely a first section, a second section, a third section and a fourth section, wherein the first section is a rigid link, wherein the second section is a rigid link, wherein the third section is a rigid link, wherein the fourth section is a rigid link; wherein the locking rim further includes a hinge mechanism that has an open position that is extended and a closed position for retaining a cell phone, wherein the first section is connected to the second section at a first hinge, wherein the second section is connected to the third section at a second hinge, wherein the third section is connected to the fourth section and a third hinge, wherein the fourth section is connected to the first section at a locking connection; wherein the first hinge, the second hinge, the third hinge are hinged to rotate in a plane parallel to a plane of the panel insert.

2. The cellular phone case of claim 1, wherein the insert panel is made of wood veneer that is generally rectangular and having rounded corners.

3. The cellular phone case of claim 1, wherein the insert panel is made of a para-aramid synthetic fiber laminate that is generally rectangular having rounded corners.

4. The cellular phone case of claim 1, further comprising: a pair of lower protrusions, wherein the pair of lower protrusions further include: a lower protrusion face that is a flat portion formed on a second hinge third section protrusion and on a third hinge third section protrusion; and a second hinge third section protrusion and a third hinge third section protrusion.

5. The cellular phone case of claim 1, further comprising a pair of lower protrusions that include a pair of lower protrusion inclines that serve as an interface between a data cutout plate and a lower protrusion face, such that the protrusion incline provides an indented surface of the data cutout plate, wherein the data cutout plate is a flat area of the third section.

6. The cellular phone case of claim 1, further comprising a lower portion of the cell phone case that has a slot cutout for providing an aperture to access ports of the cell phone, wherein the slot cutout includes a circular cutout and a data cutout, wherein the data cutout can be formed as a rectangular opening, wherein the circular cutout can be formed as a round opening, wherein the circular cutout can be sized to allow a headphone jack to interface with the access ports of the lower portion of the cell phone, wherein the data cutout can be sized to allow a data connector to interface with the access ports of the lower portion of the cell phone, wherein the data cutout is formed on the data cutout plate, wherein the data cutout plate is a flat area of a lower outside surface of the third section.

7. The cellular phone case of claim 1, further comprising a power button plate, wherein the power button plate is a flat indented area between the upper protrusions, wherein the power button plate includes a power button formed as a rigid cap inserted inside a power button opening so that a user pressing the power button can activate a power control of the cell phone, wherein the power button includes a power button stem and a power button flange extending laterally from the power button stem, wherein the power button stem fits through the power button opening by insertion from an inside side of the power button opening and is retained by the power button flange, wherein the power button stem is movable within the power button opening.

8. The cellular phone case of claim 1, further comprising a flip switch mounted on the second section in a flip switch opening, wherein the flip switch is formed as a small button, wherein the flip switch is slidingly mounted in a flip switch slot, wherein the flip switch includes a flip switch flange to retain the flip switch within the flip switch slot.

9. The cellular phone case of claim 1, further comprising a rocker switch mounted on the second section in a rocker switch opening, wherein the rocker switch includes a rocker switch first portion and a rocker switch second portion, wherein the rocker switch has a rocker switch flange to retain the rocker switch within the rocker switch opening.

10. The cellular phone case of claim 1, further comprising: a pair of upper protrusions formed on the first section, and a pair of lower protrusions formed on the third section.

11. The cellular phone case of claim 10, wherein the insert panel is made of wood veneer that is generally rectangular and having rounded corners.

12. The cellular phone case of claim 10, wherein the insert panel is made of a para-aramid synthetic fiber material that is generally rectangular having rounded corners.

13. The cellular phone case of claim 10, further comprising: a pair of upper protrusions formed on the first section, and a pair of lower protrusions formed on the third section.

14. The cellular phone case of claim 10, further comprising: a pair of lower protrusions, wherein the pair of lower protrusions further include: a lower protrusion face that is a flat portion formed on a second hinge third section protrusion and on a third hinge third section protrusion; and a second hinge third section protrusion and a third hinge third section protrusion.

15. The cellular phone case of claim 10, further comprising a pair of lower protrusions that include a pair of lower protrusion inclines that serve as an interface between a data cutout plate and a lower protrusion face, such that the protrusion incline provides an indented surface of the data cutout plate, wherein the data cutout plate is a flat area of the third section.

16. The cellular phone case of claim 10, further comprising a lower portion of the cell phone case that has a slot cutout for providing an aperture to access ports of the cell phone, wherein the slot cutout includes a circular cutout and a data cutout, wherein the data cutout can be formed as a rectangular opening, wherein the circular cutout can be formed as a round opening, wherein the circular cutout can be sized to allow a headphone jack to interface with the access ports of the lower portion of the cell phone, wherein the data cutout can be sized to allow a data connector to interface with the access ports of the lower portion of the cell phone, wherein the data cutout is formed on the data cutout plate, wherein the data cutout plate is a flat area of a lower outside surface of the third section.

17. The cellular phone case of claim 10, further comprising a power button plate, wherein the power button plate is a flat indented area between the upper protrusions, wherein the power button plate includes a power button formed as a rigid cap inserted inside a power button opening so that a user pressing the power button can activate a power control of the cell phone, wherein the power button includes a power button stem and a power button flange extending laterally from the power button stem, wherein the power button stem fits through the power button opening by insertion from an inside side of the power button opening and is retained by the power button flange, wherein the power button stem is movable within the power button opening.

18. The cellular phone case of claim 10, further comprising a flip switch mounted on the second section in a flip switch opening, wherein the flip switch is formed as a small button, wherein the flip switch is slidingly mounted in a flip switch slot, wherein the flip switch includes a flip switch flange to retain the flip switch within the flip switch slot.
